(19) United States
(12) Patent Application Publication
(10) Pub. No.: US 2019/0106827 A1
(43) Pub. Date: Apr. 11, 2019

(54) Electric Power Control Device For Laundry Treatment Apparatus

(71) Applicant: LG Electronics Inc., Seoul (KR)

(72) Inventors: Kwangchul HEO, Seoul (KR); Wooseong KIM, Seoul (KR)

(21) Appl. No.: 15/552,625

(22) PCT Filed: Feb. 22, 2016
(86) PCT No.: PCT/KR2016/001714

§ 371 Date: Aug. 22, 2017

(30) Foreign Application Priority Data
Feb. 23, 2015 (KR) 10-2015-0025102

(51) Int. Cl. D06F 33/02; D06F 58/28; D06F 29/00; H02H 3/08

(52) U.S. Cl. CPC D06F 33/02; D06F 58/28; D06F 29/005; D06F 2204/10; D06F 2058/2887; D06F 2202/12; H02H 3/08

(57) ABSTRACT

A laundry treatment apparatus includes a first treatment device that includes a first receiving unit that is configured to receive laundry, a first load unit that is configured to heat water or air in the first receiving unit, and a first electric power cable that is configured to supply electric power to the first load unit. The laundry treatment apparatus further includes a second treatment device that includes a second receiving unit that is configured to receive laundry, a second load unit that is configured to heat water or air in the second receiving unit, and a second electric power cable that is configured to supply electric power to the second load unit. The laundry treatment apparatus further includes an electric power control device that is connected to a power supply and that is configured to supply electric power to the first treatment device and to the second treatment device.

### TECHNICAL FIELD

The present disclosure relates to an electric power control device and a laundry treatment apparatus having the same.

### BACKGROUND ART

In general, a laundry treatment apparatus is a concept including an apparatus for washing laundry, an apparatus for drying laundry, and an apparatus for washing and drying laundry.

In a front loading type laundry treatment apparatus (for example, a drum type washing machine), in which laundry is introduced into the laundry treatment apparatus through the front thereof, an introduction port, through which laundry is introduced into the laundry treatment apparatus, is lower than the waist of a user, with the result that the user must stoop to introduce laundry into the laundry treatment apparatus or to remove laundry from the laundry treatment apparatus.

### DISCLOSURE OF INVENTION

### Technical Problem

An object of the subject matter described in this application lies in an electric power control device that is capable of supplying electric power to at least two treatment devices (for example, a dryer, a washer, a washer and dryer, etc.) for treating laundry and a laundry treatment apparatus having the same.

Another object of the subject matter described in this application lies in an electric power control device that is capable of preventing the operation of a first treatment device and a second treatment device for treating laundry from being simultaneously interrupted due to overcurrent when the two treatment devices are operated simultaneously and a laundry treatment apparatus having the same.

### Solution to Problem

According to an innovative aspect of the subject matter described in this application, a laundry treatment apparatus includes a first treatment device that includes a first receiving unit that is configured to receive laundry, a first load unit that is configured to heat water or air in the first receiving unit, and a first electric power cable that is configured to supply electric power to the first load unit; a second treatment device that includes a second receiving unit that is configured to receive laundry, a second load unit that is configured to heat water or air in the second receiving unit, and a second electric power cable that is configured to supply electric power to the second load unit;

and an electric power control device that is connected to a power supply and that is configured to supply electric power to the first treatment device and to the second treatment device, where the electric power control device includes: a first attachment and detachment unit that is separably coupled to the first electric power cable; a second attachment and detachment unit that is separably coupled to the second electric power cable; a first connection cable that is configured to supply electric power to the first attachment and detachment unit; a second connection cable that is configured to supply electric power to the second attachment and detachment unit; and an electric power control unit that is configured to (i) stop supplying electric power to the second connection cable or (ii) notify the second treatment device that an amount of current per unit time that is supplied to the first connection cable is equal to or greater than the reference current amount based on the amount of current per unit time that is supplied to the first connection cable being equal to or greater than a predetermined reference current amount.

The laundry treatment apparatus may include one or more of the following optional features. The second treatment device is configured to reduce an amount of current per unit time that is supplied to the second load unit based on the amount of current per unit time that is supplied to the first connection cable being equal to or greater than the reference current amount. The electric power control unit includes: a sensing unit that is located at the first connection cable and that is configured to measure an amount of current per unit time that is supplied to the first treatment device; and a communication unit that is configured to notify the second treatment device whether the amount of current per unit time measured by the sensing unit is equal to or greater than the reference current amount. The electric power control unit includes: a sensing unit that is located at the first connection cable and that is configured to measure an amount of current per unit time that is supplied to the first treatment device; a cutoff unit that is configured to electrically open and close the second connection cable; and a control unit that is configured to stop supplying electric power to the second treatment device through the cutoff unit based on the amount of current per unit time measured by the sensing unit being equal to or greater than the reference current amount.

The laundry treatment apparatus further includes a display unit that is configured to indicate whether electric power is being supplied to the second treatment device. The electric power control device further includes an input unit that is located at the power supply and that connects the first connection cable and the second connection cable to the power supply. The laundry treatment apparatus further includes: a first fastening unit that is located at the second attachment and detachment unit and that is coupled to the second electric power cable; and a second fastening unit that is located at the second electric power cable and that is coupled to the second fastening unit. The first receiving unit has a larger volume than the second receiving unit. The second treatment device is located under the first treatment device and is configured to support the first treatment device.

According to another innovative aspect of the subject matter described in this application, a laundry treatment apparatus includes a first treatment device that includes a first receiving unit that is configured to receive laundry, a first load unit that is configured to heat water or air in the first receiving unit, and a first electric power cable that is configured to supply electric power to the first load unit; a second treatment device that includes a second receiving unit that is configured to receive laundry, a second load unit that is configured to heat water or air in the second receiving unit, and a second electric power cable that is configured to supply electric power to the second load unit; a housing that is fixed to the second electric power cable; an attachment and detachment unit that is located at the housing and that is separably coupled to the first electric power cable; an input unit that is located at the housing and that is separably coupled to the power supply; a first connection cable that connects the input unit with the attachment and detachment unit and that is configured to supply electric power to the attachment and detachment unit; a second connection cable that connects the input unit with the second electric power cable; and an electric power control unit that is configured to (i) stop supplying electric power to the second load unit or (ii) reduce an amount of electric power per unit time that is supplied to the second load unit based on an amount of current per unit time that is supplied to the first connection cable being equal to or greater than a predetermined reference current amount.

The laundry treatment apparatus may include one or more of the following optional features. The electric power control unit includes: a sensing unit that is located at the first connection cable and that is configured to measure an amount of current per unit time that is supplied to the first treatment device; a cutoff unit that is configured to electrically open and close the second connection cable; and a control unit that is configured to stop supplying electric power to the second treatment device through the cutoff unit based on the amount of current per unit time measured by the sensing unit being equal to or greater than the reference current amount. The first receiving unit has a larger volume than the second receiving unit. The second treatment device is located under the first treatment device to support the first treatment device. The laundry treatment apparatus further includes a display unit that is configured to indicate whether electric power is being supplied to the second treatment device. The electric power control unit is configured to reduce an amount of electric power per unit time that is supplied to the second load unit based on an amount of current per unit time that is supplied to the first connection cable being equal to or greater than a predetermined reference current amount.

According to another innovative aspect of the subject matter described in this application, a laundry treatment apparatus includes a first treatment device that includes a first receiving unit that is configured to receive laundry, a first load unit that is configured to heat water or air in the first receiving unit, and a first electric power cable that is configured to supply electric power to the first load unit; a second treatment device that includes a second receiving unit that is configured to receive laundry, a second load unit that is configured to heat water or air in the second receiving unit, and a second electric power cable that is configured to supply electric power to the second load unit; a housing that is separate from the second treatment device; an attachment and detachment unit that is located at the housing and that is separably coupled to the first electric power cable; a connection cable that supplies electric power to the second treatment device via the second electric power cable to the attachment and detachment unit; and an electric power control unit that is configured to (i) stop supplying electric power to the second load unit or (ii) reduce an amount of electric power per unit time that is supplied to the second load unit based on an amount of current per unit time that is supplied to the connection cable being equal to or greater than a predetermined reference current amount.

The laundry treatment apparatus may include one or more of the following optional features. The electric power control unit includes: a sensing unit that is located at the connection cable and that is configured measure an amount of current per unit time that is supplied to the first treatment device; and a cutoff unit that is configured to electrically to open and close a load connection cable that is configured to supply electric power that is supplied through the second electric power cable to the second load unit, and the electric power control unit is configured to stop supplying electric power to the second load unit through the cutoff unit based on the amount of current per unit time measured by the sensing unit being equal to or greater than the reference current amount. The laundry treatment apparatus further includes a connector that is configured to separably couple the second electric power cable to the housing. The connector includes: a connector body; a housing fixing unit that is located at the connector body and that is separably coupled to the housing; and an electric power cable fixing unit that is located in the connector body and that is separably coupled to the second electric power cable. The first receiving unit has a larger volume than the second receiving unit. The second treatment device is located under the first treatment device and is configured to support the first treatment device. The laundry treatment apparatus further includes a display unit that is configured to indicate whether electric power is being supplied to the second treatment device. The electric power control unit is configured to reduce an amount of electric power per unit time that is supplied to the second load unit based on an amount of current per unit time that is supplied to the first connection cable being equal to or greater than a predetermined reference current amount.

The object of the present invention can be achieved by a laundry treatment apparatus including a first treatment device including a first receiving unit for receiving laundry, a first load unit for heating water or air in the first receiving unit, and a first electric power cable for supplying electric power to the first load unit, a second treatment device including a second receiving unit for receiving laundry, a second load unit for heating water or air in the second receiving unit, and a second electric power cable for supplying electric power to the second load unit, and an electric power control device connected to a power supply for supplying electric power to the first treatment device and the second treatment device, wherein the electric power control device includes a first attachment and detachment unit, to which the first electric power cable is separately coupled, a second attachment and detachment unit, to which the second electric power cable is separately coupled, a first connection cable for supplying electric power to the first attachment and detachment unit, a second connection cable for supplying electric power to the second attachment and detachment unit, and an electric power control unit for, when the amount of current per unit time that is supplied to the first connection cable is equal to or greater than a predetermined reference current amount, cutting off the supply of electric power to the second connection cable or notifying the second treatment device that the amount of current per unit time that is supplied to the first connection cable is equal to or greater than the reference current amount.

When the amount of current per unit time that is supplied to the first connection cable is equal to or greater than the reference current amount, the second treatment device may reduce the amount of current per unit time that is supplied to the second load unit.

The electric power control unit may include a sensing unit provided at the first connection cable for measuring the amount of current per unit time that is supplied to the first treatment device and a communication unit for notifying the second treatment device whether the amount of current per unit time measured by the sensing unit is equal to or greater than the reference current amount.

Alternatively, the electric power control unit may include a sensing unit provided at the first connection cable for measuring the amount of current per unit time that is supplied to the first treatment device, a cutoff unit for opening and closing the second connection cable, and a control unit for cutting off the supply of electric power to the second treatment device through the cutoff unit when the amount of current per unit time measured by the sensing unit is equal to or greater than the reference current amount.

The laundry treatment apparatus may further include a display unit for indicating whether electric power is being supplied to the second treatment device.

The electric power control device may further include an input unit separately provided at the power supply for connecting the first connection cable and the second connection cable to the power supply.

The laundry treatment apparatus may further include a first fastening unit provided at the second attachment and detachment unit such that the second electric power cable is coupled to the first fastening unit and a second fastening unit provided at the second electric power cable such that the second fastening unit is coupled to the first fastening unit.

The first receiving unit may have a larger volume than the second receiving unit, and the second treatment device may be provided under the first treatment device to support the first treatment device.

In another aspect of the present invention, provided herein is a laundry treatment apparatus including a first treatment device including a first receiving unit for receiving laundry, a first load unit for heating water or air in the first receiving unit, and a first electric power cable for supplying electric power to the first load unit, a second treatment device including a second receiving unit for receiving laundry, a second load unit for heating water or air in the second receiving unit, and a second electric power cable for supplying electric power to the second load unit, a housing fixed to the second electric power cable, an attachment and detachment unit provided at the housing such that the first electric power cable is separately coupled to the attachment and detachment unit, an input unit provided at the housing such that the input unit is separately coupled to the power supply, a first connection cable for connecting the input unit with the attachment and detachment unit to supply electric power to the attachment and detachment unit, a second connection cable for connecting the input unit with the second electric power cable, and an electric power control unit for cutting off the supply of electric power to the second load unit or reducing the amount of electric power per unit time that is supplied to the second load unit when the amount of current per unit time that is supplied to the first connection cable is equal to or greater than a predetermined reference current amount.

The electric power control unit may include a sensing unit provided at the first connection cable for measuring the amount of current per unit time that is supplied to the first treatment device, a cutoff unit for opening and closing the second connection cable, and a control unit for cutting off the supply of electric power to the second treatment device through the cutoff unit when the amount of current per unit time measured by the sensing unit is equal to or greater than the reference current amount.

The first receiving unit may have a larger volume than the second receiving unit, and the second treatment device may be provided under the first treatment device to support the first treatment device.

In another aspect of the present invention, provided herein is a laundry treatment apparatus including a first treatment device including a first receiving unit for receiving laundry, a first load unit for heating water or air in the first receiving unit, and a first electric power cable for supplying electric power to the first load unit, a second treatment device including a second receiving unit for receiving laundry, a second load unit for heating water or air in the second receiving unit, and a second electric power cable for supplying electric power to the second load unit, a housing provided separately from the second treatment device, an attachment and detachment unit provided at the housing such that the first electric power cable is separately coupled to the attachment and detachment unit, a connection cable for supplying at least some of the electric power that is supplied to the second treatment device via the second electric power cable to the attachment and detachment unit, and an electric power control unit for cutting off the supply of electric power to the second load unit or reducing the amount of electric power per unit time that is supplied to the second load unit when the amount of current per unit time that is supplied to the connection cable is equal to or greater than a predetermined reference current amount.

The electric power control unit may include a sensing unit provided at the connection cable for measuring the amount of current per unit time that is supplied to the first treatment device; and a cutoff unit for opening and closing a load connection cable provided to supply electric power that is supplied through the second electric power cable to the second load unit, and the electric power control unit may cut off the supply of electric power to the second load unit through the cutoff unit when the amount of current per unit time measured by the sensing unit is equal to or greater than the reference current amount.

The laundry treatment apparatus may further include a connector for separately coupling the second electric power cable to the housing.

The connector may include a connector body, a housing fixing unit provided at the connector body such that the housing is separately coupled to the housing fixing unit, and an electric power cable fixing unit provided in the connector body such that the second electric power cable is separately coupled to the electric power cable fixing unit.

The first receiving unit may have a larger volume than the second receiving unit, and the second treatment device may be provided under the first treatment device to support the first treatment device.

In a further aspect of the present invention, provided herein is an electric power control device including a first attachment and detachment unit, to which a first electric power cable for supplying electric power to a first treatment device is separately coupled, a second attachment and detachment unit, to which a second electric power cable for supplying electric power to a second treatment device is separately coupled, a first connection cable for supplying electric power to the first attachment and detachment unit, a second connection cable for supplying electric power to the second attachment and detachment unit, and an electric power control unit for, when the amount of current per unit time that is supplied to the first connection cable is equal to or greater than a predetermined reference current amount, cutting off the supply of electric power to the second connection cable or notifying the second treatment device that the amount of current per unit time that is supplied to the first connection cable is equal to or greater than the reference current amount.

The electric power control unit may include a sensing unit provided at the first connection cable for measuring the amount of current per unit time that is supplied to the first treatment device, a cutoff unit for opening and closing the second connection cable, and a control unit for cutting off the supply of electric power to the second treatment device through the cutoff unit when the amount of current per unit time measured by the sensing unit is equal to or greater than the reference current amount.

The electric power control device may further include a display unit for indicating whether electric power is being supplied to the second treatment device.

The electric power control device may further include an input unit separately provided at the power supply for connecting the first connection cable and the second connection cable to the power supply.

The input unit may be separately coupled to the power supply.

The shape of the first attachment and detachment unit may be different from that of the second attachment and detachment unit.

The electric power control device may further include a first fastening unit provided at the second attachment and detachment unit such that the second electric power cable is coupled to the first fastening unit and a second fastening unit provided at the second electric power cable such that the second fastening unit is coupled to the first fastening unit.

Alternatively, the electric power control unit may include a sensing unit provided at the first connection cable for measuring the amount of current per unit time that is supplied to the first treatment device and a communication unit for notifying the second treatment device whether the amount of current per unit time measured by the sensing unit is equal to or greater than the reference current amount.

### Advantageous Effects of Invention

As is apparent from the above description, the subject matter described in this application describes an electric power control device that is capable of supplying electric power to at least two treatment devices (for example, a dryer, a washer, a washer and dryer, etc.) for treating laundry and a laundry treatment apparatus having the same.

In addition, the subject matter described in this application describes an electric power control device that is capable of preventing the operation of a first treatment device and a second treatment device for treating laundry from being simultaneously interrupted due to overcurrent when the two treatment devices are operated simultaneously and a laundry treatment apparatus having the same.

### BRIEF DESCRIPTION OF DRAWINGS

FIGS. 1, 2, 4, and 5 are views of example laundry treatment apparatuses and example electric power control devices.

FIG. 3 is a view of an example output unit of an example electric power control device.

### BEST MODE FOR CARRYING OUT THE INVENTION

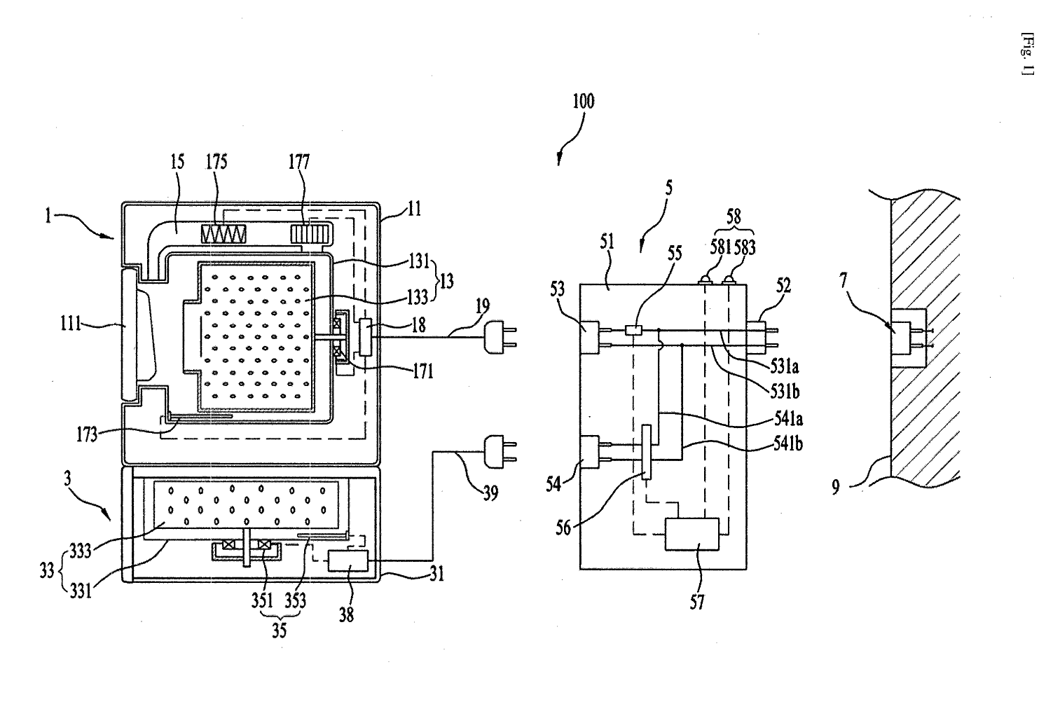

FIG. 1 illustrates an example laundry treatment apparatus with an example electric power control device.

A laundry treatment apparatus 100 includes a first treatment device 1 for treating (for example, washing, drying, or washing and drying) laundry, a second treatment device 3 for providing an additional laundry treatment space that is separate from the first treatment device 1, and an electric power control device 5 for controlling electric power that is supplied to the first treatment device 1 and the second treatment device 3.

The first treatment device 1 includes a first cabinet 11 forming the external appearance thereof and a first receiving unit 13 defined in the first cabinet 11 for providing a laundry treatment space.

The first receiving unit 13 may include a first tub 131 for providing a wash water storage space and a first drum 133 provided in the first tub 131 for receiving laundry.

The first tub 131 and the first drum 133 communicate with an introduction port provided in the first cabinet 11. The introduction port is opened and closed by a door 111.

In the first tub 131 may be provided a first heat exchange unit 173 for heating wash water. Outside the first tub 131 may be provided a motor 171 for rotating the first drum 133.

A load (a first load unit) of the first treatment device 1 having the above-described structure is constituted by the motor 171 and the first heat exchange unit 173 (here, “load” refers to an object to which electric power from a power supply is supplied).

In some implementations, the first treatment device 1 is configured as a device that is also capable of drying laundry, and a duct 15 for supplying heated air to the first tub 131 may be provided in the first cabinet 11.

In some implementations, the duct 15 is configured as a flow channel for circulating air in the first tub 131, and a second heat exchange unit 175 and a fan 177 may be provided in the duct 15.

The second heat exchange unit 175 may be configured as a device (for example, a heat pump) for removing moisture from air discharged from the first tub 131 and, additionally, for heating the dried air. In some implementations, the first load unit may be constituted by the motor 171, the first heat exchange unit 173, the second heat exchange unit 175, and the fan 177.

In some implementations, the duct 15 includes a first duct for supplying the heated air into the first tub 131 and a second duct for discharging the air in the first tub 131 out of the first cabinet, and the second heat exchange unit 175 (for example, a heat pump or a heater for emitting heat when electric power is supplied thereto) may be provided in the first duct, and the fan 177 may be provided in the second duct.

The operation of the first load unit 171, 173, 175, 177 is controlled by a first control unit 18. Electric power is supplied to the first load unit 171, 173, 175, 177 and the first control unit 18 via a first electric power cable 19.

The second treatment device 3 includes a second cabinet 31 located under the first cabinet 11 for supporting the first treatment device 1 and a second receiving unit 33 defined in the second cabinet 31 for providing a laundry receiving space.

The second receiving unit 33 may include a second tub 331 removably provided in the second cabinet 31 and a second drum 333 provided in the second tub 331 for receiving laundry.

The volume (e.g., the laundry treatment capacity) of the second receiving unit 33 may be equal to that of the first receiving unit 13. In some implementations, the volume (e.g., the laundry treatment capacity) of the second receiving unit 33 may be less than that of the first receiving unit 13. In some implementations, the volume of the second drum 333 is less than that of the first drum 133 as in the latter case, and it is possible to improve the efficiency of the laundry treatment apparatus 100 while reducing the volume of the laundry treatment apparatus 100.

In some implementations, the second treatment device 3 is a configured as a laundry washing machine, and the second tub 331 may be configured to store wash water.

In the second tub 331 may be provided a heater 353 for heating water. Outside the second tub 331 may be provided a driving unit 351 for rotating the second drum 333.

In some implementations, a load (a second load unit) 35 of the second treatment device 3 may be constituted by the driving unit 351 and the heater 353. The operation of the second load unit 35 is controlled by a second control unit 38. Electric power is supplied to the second load unit 35 and the second control unit 38 via a first electric power cable 39.

Electric power is supplied to the first treatment device 1 and the second treatment device 3 via the electric power control device 5. The electric power control device 5 may be a device that notifies at least one selected from between the first control unit 18 and the second control unit 38 whether the amount of current per unit time that is supplied to the first treatment device 1 is equal to or greater than a predetermined reference current amount. In some implementations, the electric power control device 5 may be a device that cuts off the supply of electric power to the first treatment device or to the second treatment device based on the determination of whether the amount of current per unit time that is supplied to the first treatment device 1 is equal to or greater than a predetermined reference current amount.

Elements that are directed by the electric power control device 5 to control the amount of current per unit time that is supplied to the laundry treatment apparatus may be determined based on the laundry treatment capacities of the respective treatment devices 1 and 3 or the importance of a laundry treatment cycle (or a laundry treatment course) that is being executed by each treatment device.

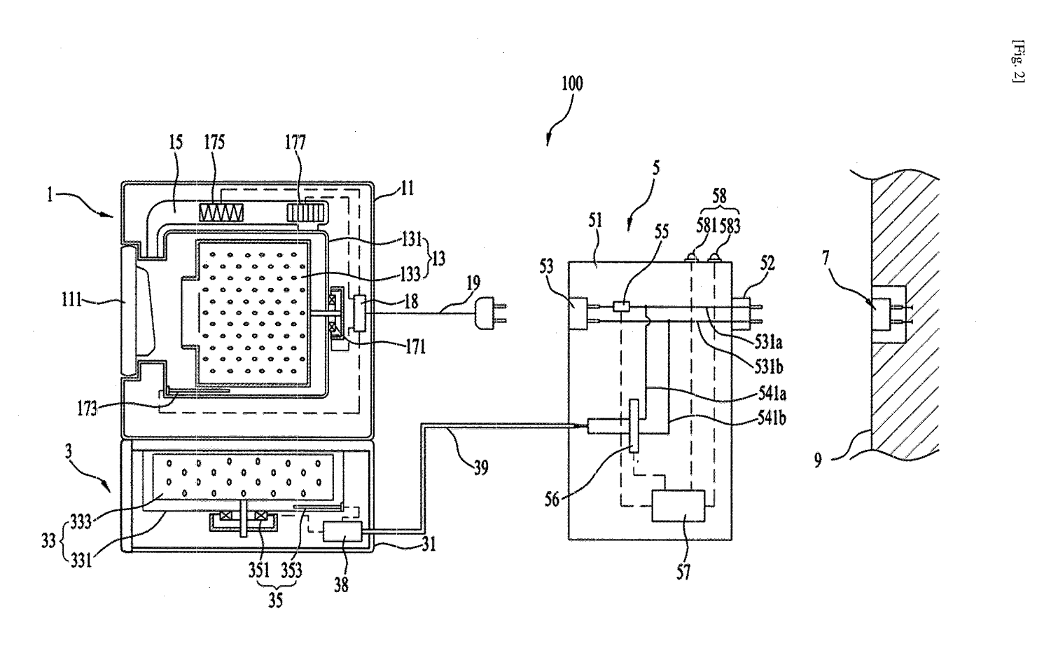

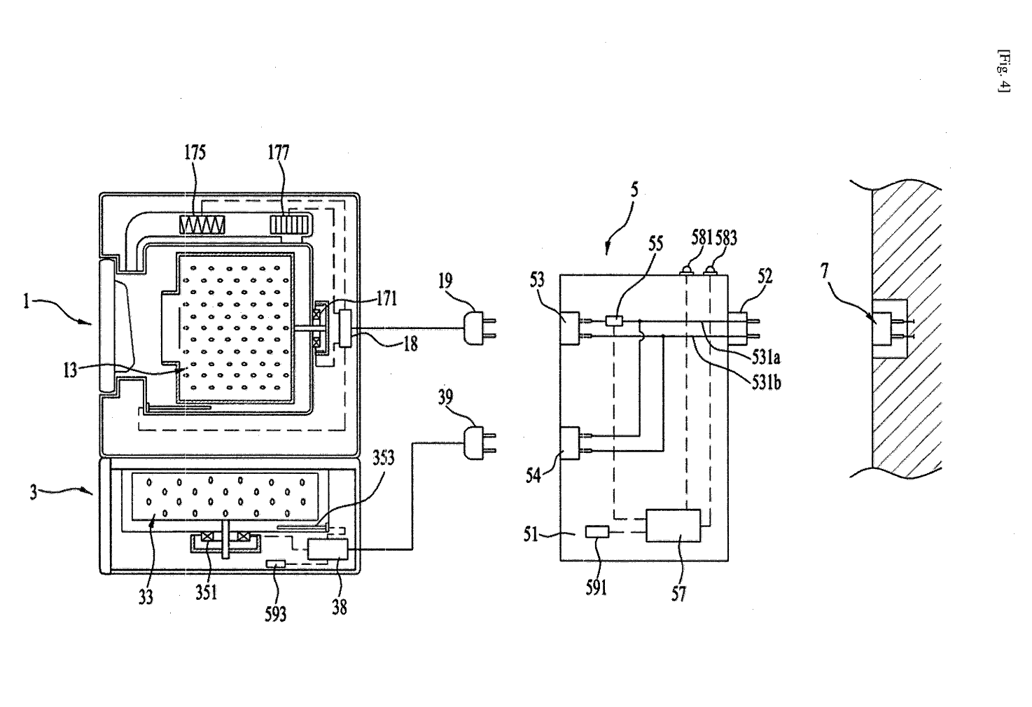

FIGS. 1 and 2 illustrate examples of an electric power control device 5 that cuts off the supply of electric power to the second treatment device 3 when the amount of current per unit time that is supplied to the first treatment device 1 is equal to or greater than the reference current amount, and FIG. 4 illustrates an example of an electric power control device 5 that notifies the second control unit 38 that it may be necessary to control the amount of current that is supplied to the second load unit 35 when the amount of current per unit time that is supplied to the first treatment device 1 is equal to or greater than the reference current amount.

Referring first to FIG. 1, the electric power control device 5 may include an input unit 52 for receiving electric power from a power supply 7, a first attachment and detachment unit 53, to which the first electric power cable 19 is removably coupled, for electrically connecting the first electric power cable 19 to the input unit 52, a second attachment and detachment unit 54, to which the second electric power cable 39 is removably coupled, for electrically connecting the second electric power cable 39 to the input unit 52, and electric power control units 55, 56, and 57 for cutting off the supply of electric power to the second electric power cable 39 based on the amount of current per unit time that is supplied to the first treatment device 1.

The electric power control device 5 may be removably provided at the power supply 7. In some implementations, the electric power control device 5 may be fixedly provided at the power supply 7. In the former case (FIG. 1), a housing 51, to which the input unit 52 is fixed, may be removable from the power supply 7. In the latter case, the housing 51 may be fixed in a room 9, and therefore the power supply 7 may be the input unit 52.

The first attachment and detachment unit 53 may include first connection cables 531a and 531b for connecting pins provided in the first electric power cable 19 to pins of the input unit 52, and the second attachment and detachment unit 54 may include second connection cables 541a and 541b for connecting pins provided in the second electric power cable 39 to the pins of the input unit 52.

The second connection cables 541a and 541b may diverge from the first connection cables 531a and 531b, respectively.

The electric power control units may include a sensing unit 55 for measuring the amount of current per unit time that is supplied to the first treatment device 1 via the first attachment and detachment unit 53, a cutoff unit 56 for opening and closing the second connection cables 541a and 541b in order to cut off the supply of electric power to the second attachment and detachment unit 54, and a control unit 57 for comparing the amount of current per unit time received from the sensing unit with the reference current amount to operate the cutoff unit 56.

The power supply 7, which is located in the room, is generally connected to an electric power cutoff device, which is configured to interrupt the supply of electric power to the power supply 7, when the amount of current per unit time that is supplied to electric home appliances through the power supply 7 exceeds a predetermined value, thereby preventing the occurrence of a fire. In a general laundry treatment apparatus, therefore, electric power from the power supply 7 may not be supplied due to the electric power cutoff device when the first load unit 171, 173, 175, 177 and the second load unit 35 are simultaneously operated.

If the supply of electric power to the input unit 52 is interrupted during the operation of the first treatment device 1 and the second treatment device 3, the operation of both the first treatment device 1 and the second treatment device 3 is interrupted. For this reason, it may be necessary to operate only one selected from between the first treatment device 1 and the second treatment device 3, which is inconvenient. Furthermore, the laundry treatment course that was being performed before the supply of electric power is interrupted must be commenced again from the beginning.

However, the electric power control device 5 may cut off the supply of electric power to the second treatment device 3, when the amount of current per unit time supplied to the first treatment device 1 has reached the reference current amount during the simultaneous operation of the first treatment device 1 and the second treatment device 3, such that the laundry treatment cycle or laundry treatment course that is being performed by the first treatment device 1 can be completed.

For example, in some implementations, the first treatment device 1 is performing a laundry treatment course using the first heat exchange unit 173 or the second heat exchange unit 175 and the second treatment device 3 is performing a laundry treatment course using the heater 353, and the amount of current per unit time that is supplied to the laundry treatment apparatus 100 through the power supply 7 may reach a level at which the electric power cutoff device can operate. This is because loads provided in the laundry treatment apparatus 100 that require the greatest amount of current are heat exchange units.

When the reference current amount is set to a value between the amount of current per unit time that may be necessary to operate at least one selected from between the first heat exchange unit 173 and the second heat exchange unit 175, provided in the first treatment device 1, and the amount of current that may be necessary to operate the electric power cutoff device, therefore, it may be possible for the laundry treatment apparatus 100 to prevent the operation of the first treatment device 1 and the second treatment device 3 from being simultaneously interrupted.

The sensing unit 55 is provided in order to measure the amount of current per unit time that is supplied to the first treatment device 1 on the assumption that, in a case in which the laundry treatment capacity of the first treatment device 1 is greater than that of the second treatment device 3, as previously described, a laundry treatment course that is performed by the first treatment device 1 has priority over a laundry treatment course that is performed by the second treatment device 3.

Consequently, the sensing unit 55 may be provided in order to measure the amount of current per unit time that is supplied to the second treatment device 3, the cutoff unit 56 may be provided in order to cut off the supply of electric power to the first attachment and detachment unit 53, and the control unit 57 may be provided in order to operate the cutoff unit 56 when the amount of current per unit time that is supplied to the second treatment device 3 is equal to or greater than the reference current amount.

Furthermore, when the sum of the amount of current per unit time that is supplied to the first treatment device 1 and the amount of current per unit time that is supplied to the second treatment device 3 is equal to or greater than the reference current amount, the cutoff unit 56 may cut off the supply of electric power to one selected from between the first treatment device 1 and the second treatment device 3

In some implementations, the sensing unit 55 may be provided in order to measure the amount of current that is supplied to the first attachment and detachment unit 53 and the amount of current that is supplied to the second attachment and detachment unit 54, and the cutoff unit 56 may be provided in order to open and close one selected from between the first connection cables 531a and 531b and the second connection cables 541a and 541b

If the operation of one selected from between the first treatment device 1 and the second treatment device 3, which are operating, is interrupted by the electric power control device 5, a user may suspect that the device that stopped operating has broken down.

In order to prevent the operation of both the two treatment devices 1 and 3 from being interrupted, therefore, it may be necessary to make the user recognize that the operation of the second treatment device 3 has been interrupted. To this end, the electric power control device 5 may be further provided with a display unit 58 for indicating that the operation of the second treatment device 3 has been interrupted when the operation of the second treatment device 3 has been interrupted.

The display unit 58 may indicate using text that the supply of electric power to the second treatment device 3 has been interrupted in order to prevent the occurrence of an accident due to overcurrent.

In addition, the display unit 58 may include a first display unit 581 for emitting light when electric power is supplied to the second treatment device and a second display unit 583 for emitting light when the supply of electric power to the second treatment device 3 has been interrupted.

In some implementations, the electric power control device 5 is designed so as to cut off only the supply of electric power to one selected from between the first treatment device 1 and the second treatment device 3 based on the amount of current per unit time that is supplied to the other, the electric power cable of the treatment device having the first priority (in FIG. 1, the first electric power cable) must be connected to the first attachment and detachment unit 53, and the electric power cable of the treatment device having the second priority (in FIG. 1, the second electric power cable) must be connected to the second attachment and detachment unit 54.

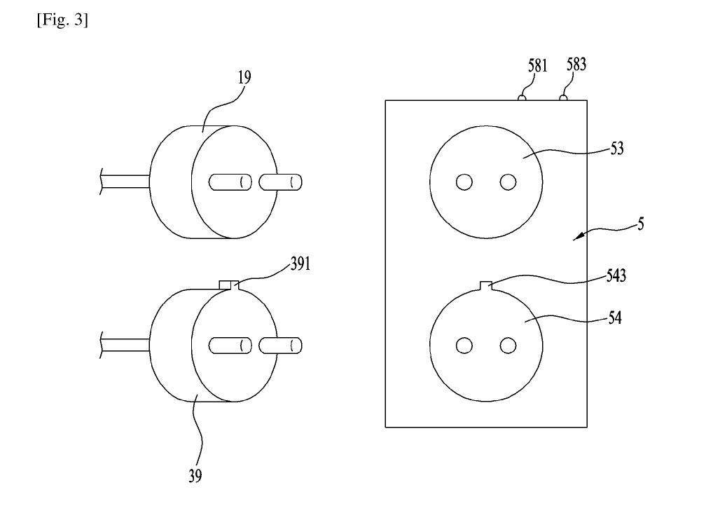

Consequently, it may be necessary to prevent the user from connecting the first electric power cable 19 to the second attachment and detachment unit 54 or from connecting the second electric power cable 39 to the first attachment and detachment unit 53. In some implementations, the electric power control device 5 may be fixed to one selected from between the first electric power cable 19 and the second electric power cable 39 in order to solve the above problem. In some implementations, a fastening unit, such as that shown in FIG. 3, may be used in order to solve the above problem.

The connection of the electric power control device 5 to the first electric power cable 19 means that the first load unit, including the first control unit 18, is connected to the input unit 52 via the first connection cables 531a and 531b, and the connection of the electric power control device 5 to the second electric power cable 39 means that the second load unit, including the second control unit 38, is connected to the input unit 52 via the second connection cables 541a and 541b.

FIG. 2 illustrates an example in which the second load unit, including the second control unit 38, is connected to the input unit 52 via the second connection cables 541a and 541b. In some implementations, the second electric power cable 39 may be directly connected to the second connection cables 541a and 541b, rather than via the second attachment and detachment unit 54.

As shown in FIG. 3, the fastening unit may include a first fastening unit provided at one selected from between the first attachment and detachment unit 53 and the second attachment and detachment unit 54 and a second fastening unit provided at the electric power cable 19 or 39, which is inserted into the attachment and detachment unit 53 or 54, at which the first fastening unit is provided, such that the second fastening unit can be coupled to the first fastening unit. In FIG. 3, there is shown an example in which the first fastening unit 543 is provided at the second attachment and detachment unit 54 and the second fastening unit 391 is provided at the second electric power cable 39.

On the assumption that a user who has already possessed the first treatment device 1 additionally buys the second treatment device 3 and the electric power control device 5, it may be advantageous for the second fastening unit 391 to be provided at the second electric power cable 39 and for the first fastening unit 543 to be provided at the second attachment and detachment unit 54, since the user may not be able to recognize the shape of the first electric power cable 19 depending upon the manufacturer or model number of the first treatment device 1.

The electric power control device 5 is configured to have a structure that reduces the amount of current per unit time that is supplied to the second treatment device 3, or interrupts the operation of the second treatment device 3, when the amount of current per unit time that is supplied to the first treatment device 1 reaches the reference current amount, whereby it is difficult to maintain the second treatment device 3 in a state in which the second treatment device 3 is connected to the power supply.

The laundry treatment apparatus 100 of FIG. 4 is characterized in that, when the amount of current per unit time that is supplied to the laundry treatment apparatus 100 reaches the reference current amount, the laundry treatment course or the laundry treatment cycle (constituting the laundry treatment course) that is being performed by one selected from between the first treatment device 1 and the second treatment device 3 is continuously executed, and the laundry treatment course or the laundry treatment cycle of the other treatment device is changed or temporarily interrupted while electric power is supplied to the other treatment device.

That is, the electric power control device 5 of FIG. 4 is characterized in that, when the amount of current per unit time that is supplied to the first treatment device 1 reaches the reference current amount, the electric power control device 5 notifies the second treatment device 3 of the same such that the second control unit 38 can control the operation of the second load unit 35.

The electric power control units provided in the electric power control device 5 may include a sensing unit 55 for measuring the amount of current per unit time that is supplied to the first attachment and detachment unit 53, a control unit 57 for determining whether the amount of current per unit time measured by the sensing unit 55 is equal to or greater than the reference current amount, and a communication unit for transmitting a signal indicating whether the amount of current per unit time that is supplied to the first attachment and detachment unit 53 is equal to or greater than the reference current amount to the second treatment device 3.

The communication unit may communicate with the second treatment device 3 in a wired communication fashion. In some implementations, the communication unit may communicate with the second treatment device 3 in a wireless communication fashion.

In the former case, the communication unit may include a communication cable for directly connecting the control unit 57, which is provided in the electric power control device 5, with the second control unit 38, which is provided in the second treatment device 3. In the latter case, the communication unit may include a first communication unit 591 connected to the control unit 57 and a second communication unit 593 connected to the second control unit 38.

In some implementations, when the second communication unit 593 receives a signal transmitted by the first communication unit 591, the second control unit 38 may temporarily interrupt the overall operation of the second load unit 35 (may temporarily interrupt the laundry treatment course), or may interrupt the operation of some of the loads constituting the second load unit 35 (may change the laundry treatment course).

In addition, when the operation of at least one of the loads constituting the second load unit 35 is interrupted, the second control unit 38 may notify the user of the same through a display unit. The display unit may include a first display unit 581 for emitting light when the second load unit 35 is operating normally and a second display unit 583 for emitting light when the operation of at least some of the loads constituting the second load unit 35 is interrupted.

The electric power control device 5 may be fixed to the first treatment device 1 or to the second treatment device 3. In some implementations, the electric power control device 5 is fixed to the first cabinet 11 of the first treatment device 1 or to the second cabinet 31 of the second treatment device 3, and, however, the first electric power cable 19 or the second electric power cable 39 may be separated from the electric power control device 5 due to vibration generated from the first treatment device 1 or the second treatment device 3 during the operation of the first treatment device 1 or the second treatment device 3. For this reason, it may be advantageous for the electric power control device 5 not to be fixed to the two cabinets 11 and 31.

In some implementations, for example, FIG. 4, it may be necessary to prevent the first electric power cable 19 from being connected to the second attachment and detachment unit 54 or to prevent the second electric power cable 39 from being connected to the first attachment and detachment unit 53. To this end, the electric power control device 5 may further include the fastening units 543 and 391 shown in FIG. 3, and one selected from between the first electric power cable 19 and the second electric power cable 39 may be fixed to the electric power control device 5.

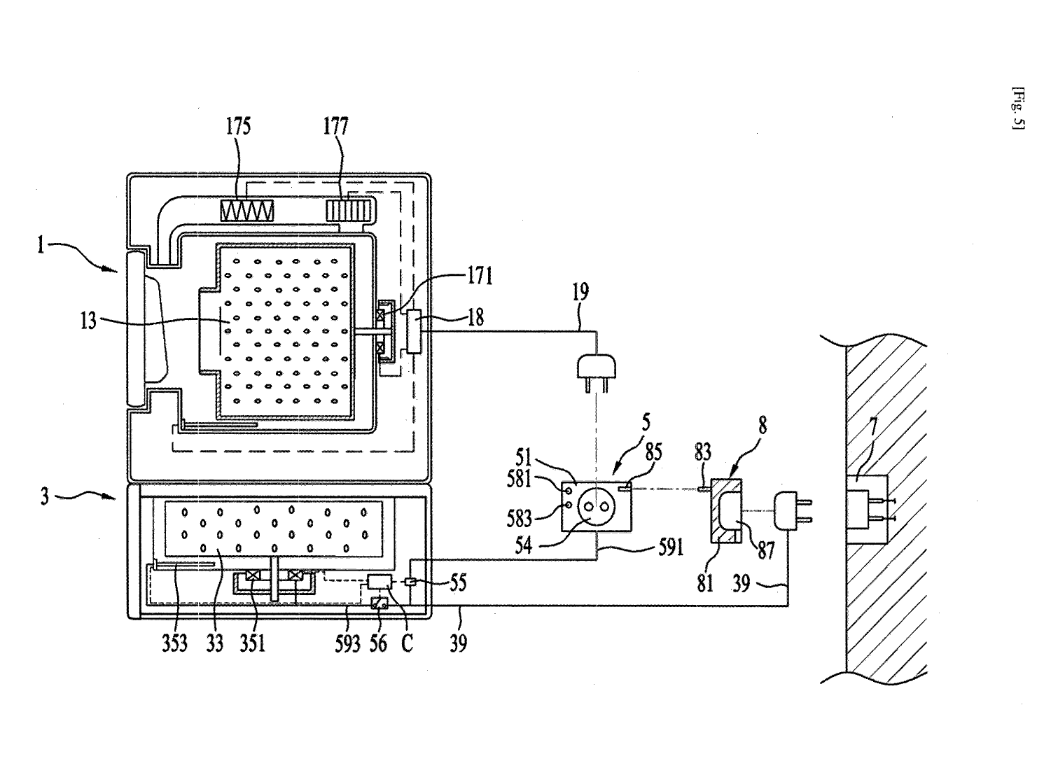

FIG. 5 illustrates an example laundry treatment apparatus with an example electric power control device 5. The electric power control device 5 is characterized in that the electric power control device 5 is provided in the second treatment device 3 to supply at least some of the electric power that is supplied to the second treatment device 3 via the second electric power cable 39 to the first treatment device 1.

The electric power control device 5 includes a housing 51 provided separately from the second treatment device 3, an attachment and detachment unit 54 provided at the housing 51 such that the first electric power cable 19, provided in the first treatment device 1, is separately coupled to the attachment and detachment unit 54, a connection cable 591 for supplying at least some of the electric power that is supplied to the second treatment device 3 via the second electric power cable 39 to the attachment and detachment unit 54, a sensing unit 55 for measuring the amount of current per unit time that is supplied to the connection cable 591, and an electric power control unit C for cutting off the supply of electric power to the second load unit 35 or reducing the amount of electric power per unit time that is supplied to the second load unit 35 while supplying electric power to the connection cable 591 when the amount of current per unit time that is supplied to the connection cable 591 is equal to or greater than a predetermined reference current amount.

In some implementations, the electric power control unit C is configured to cut off the supply of electric power to the second load unit 35 when the amount of current per unit time that is supplied to the connection cable 591 is equal to or greater than the reference current amount, and the second electric power cable 39 may be further provided with a cutoff unit 56 configured to be opened and closed according to a control signal from the electric power control unit C. The cutoff unit 56 may be configured to open and close a load connection cable 593 provided to supply electric power that is supplied through the second electric power cable 39 to the second load unit 35.

In some implementations, the electric power control unit C is configured to reduce the amount of electric power that is supplied to the second load unit 35 when the amount of current per unit time that is supplied to the connection cable 591 is equal to or greater than the reference current amount, and the cutoff unit 56 may be omitted. In some implementations, the electric power control unit C may operate the second load unit 35 such that electric power is supplied to only some of the loads constituting the second load unit 35 or such that the amount of current per unit time that is supplied to some of the loads constituting the second load unit 35 is reduced.

The electric power control unit C may be the second control unit, which is provided in the second treatment device, or may be an additional control unit provided separately from the second control unit.

In some implementations, when the operation of at least one of the loads constituting the second load unit 35 is interrupted, the user may be notified of the same through a display unit. The display unit may include a first display unit 581 for emitting light when the second load unit 35 is operating normally and a second display unit 583 for emitting light when the operation of at least some of the loads constituting the second load unit 35 is interrupted.

In addition, the electric power control device 5 may further include a connector 8 for separately coupling the second electric power cable 39 to the housing 51. The connector 8 may include a connector body 81, a housing fixing unit 83 and 85 provided at the connector body 81 such that the housing 51 is separately coupled to the housing fixing unit 83 and 85, and an electric power cable fixing unit 87 provided in the connector body 81 such that the second electric power cable 39 is separately coupled to the electric power cable fixing unit 87.

The housing fixing unit 83 and 85 may include a first fixing unit 83 protruding from the connector body 81 and a second fixing unit 85 provided in the housing 51 such that the first fixing unit is inserted into the second fixing unit 85. The electric power cable fixing unit 87 may be configured as a receiving recess formed in the connector body 81 for allowing the second electric power cable 39 to be separably mounted therein.

In general, the power supply 7 is located above the ground. When the connector 8 is provided to couple the electric power control device 5 to the second electric power cable 39, therefore, it is possible to prevent the first attachment and detachment unit 53, to which the first electric power cable 19 is coupled, from contacting water on the ground.

The subject matter described above provides an electric power control device that is capable of supplying electric power to at least two treatment devices (for example, a dryer, a washer, a washer and dryer, etc.) for treating laundry and a laundry treatment apparatus having the same.

In addition, the subject matter described above provides an electric power control device that is capable of preventing the operation of a first treatment device and a second treatment device for treating laundry from being simultaneously interrupted due to overcurrent when the two treatment devices are operated simultaneously and a laundry treatment apparatus having the same.

1. A laundry treatment apparatus comprising:
a first treatment device comprising a first receiving unit that is configured to receive laundry, a first load unit that is configured to heat water or air in the first receiving unit, and a first electric power cable that is configured to supply electric power to the first load unit;
a second treatment device comprising a second receiving unit that is configured to receive laundry, a second load unit that is configured to heat water or air in the second receiving unit, and a second electric power cable that is configured to supply electric power to the second load unit; and
an electric power control device that is connected to a power supply and that is configured to supply electric power to the first treatment device and to the second treatment device, wherein the electric power control device comprises:
a first attachment and detachment unit that is separably coupled to the first electric power cable;
a second attachment and detachment unit that is separably coupled to the second electric power cable;
a first connection cable that is configured to supply electric power to the first attachment and detachment unit;
a second connection cable that is configured to supply electric power to the second attachment and detachment unit; and
an electric power control unit that is configured to (i) stop supplying electric power to the second connection cable or (ii) notify the second treatment device that an amount of current per unit time that is supplied to the first connection cable is equal to or greater than the reference current amount based on the amount of current per unit time that is supplied to the first connection cable being equal to or greater than a predetermined reference current amount.

2. The laundry treatment apparatus according to claim 1, wherein the second treatment device is configured to reduce an amount of current per unit time that is supplied to the second load unit based on the amount of current per unit time that is supplied to the first connection cable being equal to or greater than the reference current amount.

3. The laundry treatment apparatus according to claim 2, wherein the electric power control unit comprises:
a sensing unit that is located at the first connection cable and that is configured to measure an amount of current per unit time that is supplied to the first treatment device; and
a communication unit that is configured to notify the second treatment device whether the amount of current per unit time measured by the sensing unit is equal to or greater than the reference current amount.

4. The laundry treatment apparatus according to claim 1, wherein the electric power control unit comprises:
a sensing unit that is located at the first connection cable and that is configured to measure an amount of current per unit time that is supplied to the first treatment device;
a cutoff unit that is configured to electrically open and close the second connection cable; and
a control unit that is configured to stop supplying electric power to the second treatment device through the cutoff unit based on the amount of current per unit time measured by the sensing unit being equal to or greater than the reference current amount.

5. The laundry treatment apparatus according to claim 1, further comprising a display unit that is configured to indicate whether electric power is being supplied to the second treatment device.

6. The laundry treatment apparatus according to claim 1, wherein the electric power control device further comprises an input unit that is located at the power supply and that connects the first connection cable and the second connection cable to the power supply.

7. The laundry treatment apparatus according to claim 1, further comprising:
a first fastening unit that is located at the second attachment and detachment unit and that is coupled to the second electric power cable; and
a second fastening unit that is located at the second electric power cable and that is coupled to the second fastening unit.

8. The laundry treatment apparatus according to claim 1, wherein:
the first receiving unit has a larger volume than the second receiving unit, and
the second treatment device is located under the first treatment device and is configured to support the first treatment device.

9. A laundry treatment apparatus comprising:
a first treatment device comprising a first receiving unit that is configured to receive laundry, a first load unit that is configured to heat water or air in the first receiving unit, and a first electric power cable that is configured to supply electric power to the first load unit;
a second treatment device comprising a second receiving unit that is configured to receive laundry, a second load unit that is configured to heat water or air in the second receiving unit, and a second electric power cable that is configured to supply electric power to the second load unit;
a housing that is fixed to the second electric power cable;
an attachment and detachment unit that is located at the housing and that is separably coupled to the first electric power cable;
an input unit that is located at the housing and that is separably coupled to the power supply;
a first connection cable that connects the input unit with the attachment and detachment unit and that is configured to supply electric power to the attachment and detachment unit;
a second connection cable that connects the input unit with the second electric power cable; and
an electric power control unit that is configured to (i) stop supplying electric power to the second load unit or (ii) reduce an amount of electric power per unit time that is supplied to the second load unit based on an amount of current per unit time that is supplied to the first connection cable being equal to or greater than a predetermined reference current amount.

10. The laundry treatment apparatus according to claim 9, wherein the electric power control unit comprises:
a sensing unit that is located at the first connection cable and that is configured to measure an amount of current per unit time that is supplied to the first treatment device;
a cutoff unit that is configured to electrically open and close the second connection cable; and
a control unit that is configured to stop supplying electric power to the second treatment device through the cutoff unit based on the amount of current per unit time measured by the sensing unit being equal to or greater than the reference current amount.

11. The laundry treatment apparatus according to claim 9, wherein:
the first receiving unit has a larger volume than the second receiving unit, and
the second treatment device is located under the first treatment device to support the first treatment device.

12. The laundry treatment apparatus according to claim 9, further comprising a display unit that is configured to indicate whether electric power is being supplied to the second treatment device.

13. The laundry treatment apparatus according to claim 9, wherein the electric power control unit is configured to reduce an amount of electric power per unit time that is supplied to the second load unit based on an amount of current per unit time that is supplied to the first connection cable being equal to or greater than a predetermined reference current amount.

14. A laundry treatment apparatus comprising:
a first treatment device comprising a first receiving unit that is configured to receive laundry, a first load unit that is configured to heat water or air in the first receiving unit, and a first electric power cable that is configured to supply electric power to the first load unit;
a second treatment device comprising a second receiving unit that is configured to receive laundry, a second load unit that is configured to heat water or air in the second receiving unit, and a second electric power cable that is configured to supply electric power to the second load unit;
a housing that is separate from the second treatment device;
an attachment and detachment unit that is located at the housing and that is separably coupled to the first electric power cable;
a connection cable that supplies electric power to the second treatment device via the second electric power cable to the attachment and detachment unit; and
an electric power control unit that is configured to (i) stop supplying electric power to the second load unit or (ii) reduce an amount of electric power per unit time that is supplied to the second load unit based on an amount of current per unit time that is supplied to the connection cable being equal to or greater than a predetermined reference current amount.

15. The laundry treatment apparatus according to claim 14, wherein:
the electric power control unit comprises:
a sensing unit that is located at the connection cable and that is configured measure an amount of current per unit time that is supplied to the first treatment device; and
a cutoff unit that is configured to electrically to open and close a load connection cable that is configured to supply electric power that is supplied through the second electric power cable to the second load unit, and
the electric power control unit is configured to stop supplying electric power to the second load unit through the cutoff unit based on the amount of current per unit time measured by the sensing unit being equal to or greater than the reference current amount.

16. The laundry treatment apparatus according to claim 14, further comprising a connector that is configured to separably couple the second electric power cable to the housing.

17. The laundry treatment apparatus according to claim 16, wherein the connector comprises:
a connector body;
a housing fixing unit that is located at the connector body and that is separably coupled to the housing; and
an electric power cable fixing unit that is located in the connector body and that is separably coupled to the second electric power cable.

18. The laundry treatment apparatus according to claim 14, wherein:
the first receiving unit has a larger volume than the second receiving unit, and
the second treatment device is located under the first treatment device and is configured to support the first treatment device.

19. The laundry treatment apparatus according to claim 12, further comprising a display unit that is configured to indicate whether electric power is being supplied to the second treatment device.

20. The laundry treatment apparatus according to claim 12, wherein the electric power control unit is configured to reduce an amount of electric power per unit time that is supplied to the second load unit based on an amount of current per unit time that is supplied to the first connection cable being equal to or greater than a predetermined reference current amount.
